(19) United States
(12) Patent Application Publication
(10) Pub. No.: US 2011/0128752 A1
(43) Pub. Date: Jun. 2, 2011

(54) APPARATUS AND METHOD FOR ATTACHING A FAN OF A LIGHTING APPARATUS AND LIGHTING APPARATUS

(75) Inventors: Thomas Herbers, Lippstadt (DE); Jürgen Schulte, Buren (DE); Gerd Hammelbeck, Lippstadt (DE)

(73) Assignee: HELLA KGAA HUECK & CO., Lippstadt (DE)

(21) Appl. No.: 12/951,182

(22) Filed: Nov. 22, 2010

(30) Foreign Application Priority Data
Nov. 25, 2009 (EP) 09 177 011.5

(51) Int. Cl. F21S 8/10; B60Q 1/00; F16M 13/02

(52) U.S. Cl. 362/545; 362/547; 248/674

(57) ABSTRACT

The present invention relates to a device for attaching a fan of a lighting apparatus, characterized in that the device comprises at least one mounting element for mounting the fan and at least one mounting device for mounting the device inside the lighting apparatus. The invention further relates to a lighting apparatus of a vehicle, comprising a light source, a fan and a housing, wherein the light source is mounted inside and/or on the housing and wherein the lighting apparatus comprises an fan attachment device of the aforementioned type.

### CROSS-REFERENCE TO RELATED APPLICATIONS

The present application claims priority to and incorporates herein by reference European Patent Application Serial No. 09 177 011.5 filed on Nov. 25, 2009.

### FIELD OF THE INVENTION

The subject matter of the invention is a device for attaching a fan of a lighting apparatus and a lighting apparatus of a vehicle comprising a light source, a fan and a housing, wherein the light source is mounted inside and/or on the housing.

### BACKGROUND

In the vehicle sector, particularly in the motor vehicle sector, it is an established fact that a lighting apparatus comprises a fan that allows air to circulate inside the lighting apparatus in order to cool said apparatus. The fan is permanently installed, or forms an integral whole with components such as the light source or a ventilation duct, in the lighting apparatus such that the fan cannot be easily removed once the lighting apparatus has been assembled.

For example, DE 10 2005 060 736 A1 discloses a headlamp comprising a headlamp housing containing a light source and an apparatus for conveying air, particularly in the shape of a ventilator. The apparatus for conveying air, particularly the ventilator, is located in the rear area of the headlamp or between the rear wall of the headlamp and a heat sink. In a headlamp of this design, the apparatus for conveying air cannot be easily removed.

DE 10 2007 043 961 A1 discloses a lighting apparatus comprising at least one semiconductor light source. The lighting apparatus comprises an almost entirely closed air duct mainly extending in horizontal direction. The lighting apparatus also comprises means for actively conveying air through the air duct. These means for conveying air may comprise a blower. The means for conveying air form an integral whole with the air duct. For example, the means for conveying air may be mounted to one end of the air duct. The fan cannot be easily and separately removed from the lighting apparatus because it is linked to the means for conveying air.

### SUMMARY

The present invention is an apparatus that allows a fan to be easily installed in and/or removed from a lighting apparatus, particularly a lighting apparatus for a vehicle. It is also a lighting apparatus that a fan can be easily installed in or removed from.

Further attributes and details of the invention are disclosed in the dependent claims, the description and the drawings. Attributes and details described for the mounting device do of course apply to the lighting apparatus also and vice versa.

According to the first aspect of the invention, a device for attaching a fan of a lighting apparatus, comprises at least one mounting element for mounting the fan and at least one mounting device for mounting the device inside the lighting apparatus.

Such type of device for attaching a fan of a lighting apparatus allows a fan to be easily installed in or removed from the lighting apparatus, particularly the lighting apparatus of a motor vehicle. In lighting apparatuses comprising at least one light emitting diode as their light source, the fan is to be particularly considered a wearing part which may have to be replaced due to a failure. The device allows the fan to be easily replaced in the lighting apparatus, for example a headlamp of a vehicle, particularly a motor vehicle. Another advantage of the device is that the fan can be mounted away from the opening in the lighting apparatus through which the fan is moved to the inside of the lighting apparatus. The position of the fan inside the lighting apparatus is determined by the at least one mounting element of the device that the fan is attached to and/or the position of the at least one mounting element in relation to the at least one mounting device that mounts the device in and/or to the lighting apparatus. A feature is that the device can be mounted using a tool such as a screwdriver that can be inserted through the opening. Since the fan can be mounted to the device prior to installation, there is no need for accessing the at least one mounting element with a tool through the insert opening after installing the fan in the lighting apparatus.

The housing of the lighting apparatus or a frame inside the lighting apparatus may be made of a thermoset material. Due to the special material that such housing or frame is made of, a bolt can only be screwed in once. As opposed to that, the device that should preferably be made of a different material such as a thermoplastic material allows bolts for attaching the fan to the device to be screwed in several times.

The device may have two or more mounting elements for attaching the fan. Another preferred attribute is that the device should comprise two or more mounting devices for mounting the device inside the lighting apparatus. This is to ensure that the device is safely attached inside the lighting apparatus and that the fan is safely attached to the device.

In one embodiment of the invention, the at least one mounting device of the device may have an unthreaded hole or a hole with an inside thread along at least some of its length in it for holding a bolt. Such mounting implements allow the device to be mounted inside the lighting apparatus and particularly on the inner wall of the housing of the lighting apparatus by simply using bolts. Appropriate seating elements such as anchors may be provided to hold the bolts inside the lighting apparatus, particularly in the wall of the housing of the lighting apparatus or in a frame located inside the lighting apparatus. These seating elements, particularly the anchors, may slot into through-holes or pocket holes in the housing of the lighting apparatus or in the frame located inside the lighting apparatus.

The attachment device of another embodiment comprises at least one mounting device with a guiding element to provide a captive guide to a bolt. Such guiding element prevents the bolt from dropping into the lighting apparatus or into the housing of the lighting apparatus and from no longer being accessible, for example after unscrewing it. The guiding element should be preferably designed such that the bolt can be moved inside the guiding element along one degree of freedom, i.e. in one direction. A direction of movement of the bolt may be parallel or coaxial to the long axis of the guiding element. The guiding element could be designed as a sliding link, for example. The guiding element allows the bolt to be safely inserted in the through-hole in the attachment device and screwed into the matching seating elements inside the lighting apparatus, particularly into seating elements located in the housing of the lighting apparatus or a frame located inside the lighting apparatus. The guiding element of the at least one mounting device is located on the attachment device such that the bolt is aligned with the hole through the attachment device. That is to say, the guiding element is located on the attachment device such that the long axis of the bolt going through the guiding element is coaxial to the long axis of a hole through the attachment device. This provides for a very simple way of mounting the at least one bolt and, thus, the attachment device on the inside of the lighting apparatus.

Another embodiment comprises a low-noise design of the replaceable fan attachment device. Thus, the attachment device may be mounted on the inside of the lighting apparatus in a firm and vibration-proof manner such that operating the fan does not produce any noise from movements of the attachment device. Special gaskets or washers could be appropriate means for this purpose.

Another advancement of the invention comprises an attachment device that the guiding element is friction-locked to the attachment device, particularly by one or several locating elements, but removable from it. For example, the guiding element may comprise lugs that slot into matching snap-in holes in the attachment device. Alternatively or additionally, the guiding element may comprise snap-in holes that matching lugs on the attachment device slot into. The at least one locating element is preferably resilient. Exerting a force on the at least one locating element allows the guiding element to be snapped off the attachment device. In another advantageous variant of the guiding element, the friction-locked link may be provided by a bayonet mount.

Another variant of the attachment device comprises a guiding element able to pivot on the attachment device. In one design, the guiding element forms an integral whole with the attachment device. That is to say, the guiding element of the at least one mounting device and the attachment device are made in a monolithic manner. In one embodiment, the guiding element may be mounted on the at least one mounting device by means of an integral hinge to form an integral or monolithic whole with the attachment device. That is to say, an integral hinge is the preferred means of turning the guiding element, acting as screw hole of the mounting device, and the attachment device into an integral whole. The attachment device and the guiding elements designed as screw holes can be manufactured by injection molding at the normal tool position and without need for a gate valve.

In another advancement of the invention, the at least one mounting element of the attachment device comprises a through-hole with or without an inside thread or a pocket hole with or without an inside thread. By designing the at least one mounting element as a through-hole or pocket hole, the fan can be easily attached to and removed from the attachment device by means of bolts. After mounting the at least one mounting element on the attachment device and installing the attachment device in the lighting apparatus, the through-holes or pocket holes in particular may be located in the lighting apparatus such that there is not access to them from the outside. The fan is simply uninstalled by uninstalling the attachment device it is mounted on. The through-hole in the at least one mounting device preferably tilts towards the through-hole or pocket hole in the at least one mounting element. That is to say, the fan can be arranged or placed in any position because it can be mounted on the attachment device prior to installing said attachment device in the lighting apparatus. By the fan mounting position being independent of where the attachment device is mounted in the lighting apparatus, any fan position, particularly a fan position optimized in relation to the cooling elements in the lighting apparatus, is ensured to respond to the design of the mounting elements.

The attachment device is preferably made of a thermoplastic material. Thermoplastic injection molding can be deployed to make the attachment device. Another design variant of the attachment device may provide for the device being made of metal.

According to a second aspect of the invention, the task is accomplished by a lighting apparatus for a vehicle, particularly a motor vehicle, comprising a light source, a fan and a housing, wherein the light source is mounted in and/or on the housing. Under this aspect, the lighting apparatus is characterized by comprising an attachment device for the fan pursuant to the first aspect of the invention and by the housing having an opening for inserting the attachment device and fan, wherein the attachment device is mounted in and/or on the housing of the lighting apparatus but removable from it such that the attachment device can be mounted to/dismounted from the housing of the lighting apparatus through said opening.

A lighting apparatus of the aforementioned type allows a defective fan to be quickly and easily removed from the lighting apparatus, for example a headlamp or the tail lamp of a motor vehicle. This is particularly advantageous in latest generation lighting equipment, particularly of motor vehicles, because in such lighting equipment the fan is the wearing part and not the light sources. In a lighting apparatus of the aforementioned type, the attachment device makes it very easy to install the fan in said lighting apparatus or uninstall the fan from it. One factor is that both the fan and the attachment device can be guided through the opening in the housing of the lighting apparatus. The at least one light source of the lighting apparatus can also be installed in or uninstalled through the same opening. It is of advantage to close said opening with a closing element such as a lid and particularly a sealing lid. The attachment device may be mounted with screws on the inside of the lighting apparatus. Such screws can be turned in or out with a screwdriver such as a torx screwdriver that can be inserted in the mounting device through said opening.

According to another advancement of the invention, the lighting apparatus may provide means of mounting and removing the attachment device and/or the light source on/from a frame inside the housing of the lighting apparatus.

The light source of the lighting apparatus can be of various designs. A lighting apparatus comprising at least one light emitting diode (LED) as its light source is particularly preferred.

Further features and advantages of the present invention, as well as the structure and operation of various embodiments of the present invention, are described in detail below with reference to the accompanying drawings.

### BRIEF DESCRIPTION OF THE DRAWINGS

The figures attached hereto are taken to further explain the invention.

The following is shown:

FIG. 1 top view of a fan located on an attachment device of a lighting apparatus;

FIG. 2 lateral view of a fan located on an attachment device of a lighting apparatus;

FIG. 3 attachment device of a fan and a fan in the position of installing it in a lighting apparatus of a motor vehicle;

FIG. 4 perspective view of a fan attachment device with guiding elements mounted on the attachment device by integral hinges such that the guiding elements are able to pivot, wherein the guiding elements are open so that a bolt can be screwed in;

FIG. 5 perspective view of a fan attachment device with guiding elements mounted on the attachment device by integral hinges such that the guiding elements are able to pivot, wherein the guiding elements are shown at their mounting position.

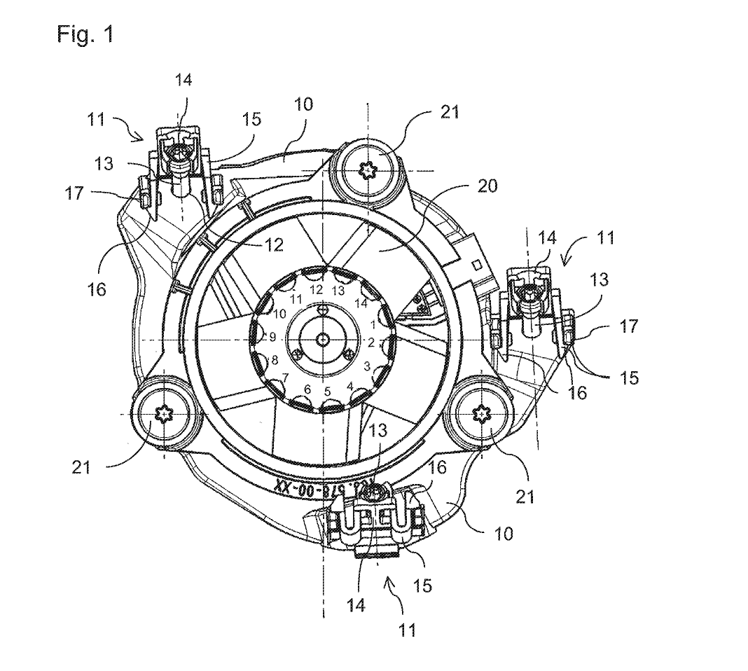

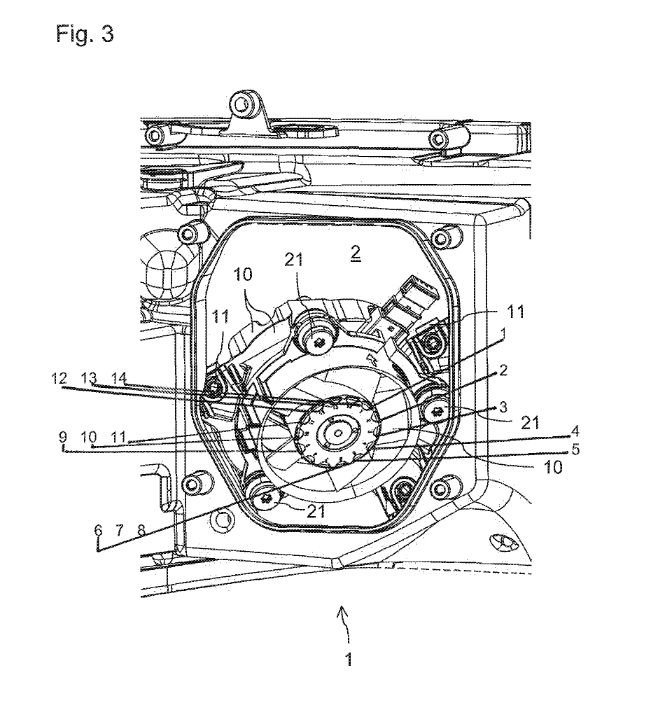

FIGS. 1 and 3 assign identical reference numbers to elements of the same function and mode of operation.

### DETAILED DESCRIPTION OF THE DRAWINGS

FIG. 1 is a top view of a fan 20 located on an attachment device 10 of a lighting apparatus 1. The fan 20 is mounted on and can be removed from the attachment device 10 by bolts 21. The bolts 21 are screwed into matching mounting elements which are not shown. The mounting elements are preferably designed as through-holes or pocket holes. The through-holes or pocket holes may or may not have an inside thread for holding the bolts. The attachment device 10 and the at least one mounting element of attachment device 10 in particular, is preferably made from a material that allows a bolt 21 to be screwed in and out a plurality of times. The attachment device 10 and/or the at least one mounting element of attachment device 10 are preferably made of a thermoplastic material.

The attachment device 10 comprises mounting devices 11 with through-holes or bore holes 12. Said holes serve the purpose of using bolts 13 to screw the attachment device 10 to the inside of the lighting apparatus 1, particularly to the inner wall of the housing of said lighting apparatus 1 or to a frame inside said lighting apparatus 1. The mounting devices 11 of the attachment device 10 further comprise guiding elements 14 designed to hold the bolts 13 in a captive manner. The guiding elements 14 are preferably mounted to the attachment device 10 such that they are pivotable. Particularly, the pivoting guiding elements 14 make up an integral whole with the attachment device 10. Particularly, an integral hinge lets the guiding elements 14 form an integral whole with and pivot on the attachment device 10. The guiding elements 14 comprise locating elements 15 of a preferably resilient design and featuring lugs 16 at their free ends. The locating elements 15 of the guiding elements 14 snap into or onto matching slots 17 in the attachment device 10. FIG. 1 shows these as parts protruding from the attachment device 10. In this design variant of the attachment device 10, the holes 12 going through the mounting devices 11 of the attachment device tilt towards the through-holes or pocket holes in the mounting elements of the attachment element 10.

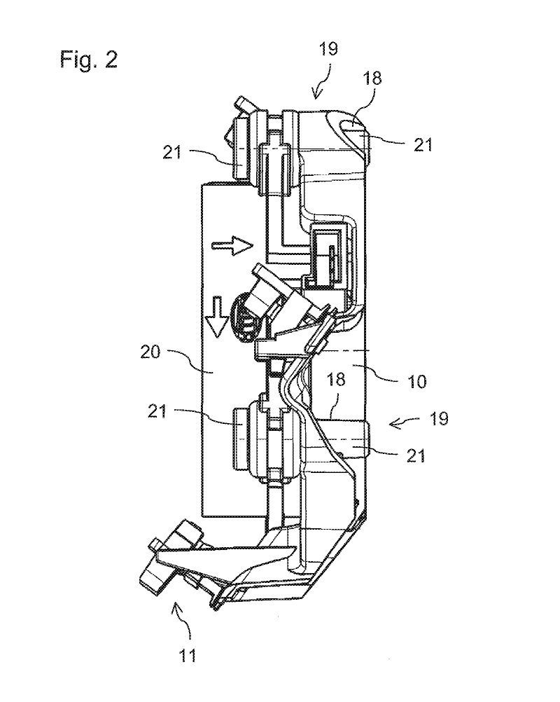

FIG. 2 shows a lateral view of a fan 20 located on an attachment device 10 of a lighting apparatus 1. The attachment device 10 comprises mounting devices 11 preferably designed as through-holes. Said holes serve the purpose of mounting the attachment device 10 to the lighting apparatus 1, particularly to the inner wall of the lighting apparatus 1 or to a frame inside the lighting apparatus 1. Mounting involves putting the bolts into the through-holes. The attachment device 10 further comprises mounting elements 19 designed as through-holes 18. The purpose of the mounting devices 19 is to mount the fan 20 on the attachment device 10. That is to say, the fan 20 is mounted on and can be removed from the attachment device 10 by means of bolts screwed into the through-holes 18.

FIG. 3 shows an attachment device 10 for a fan 20 and a fan 20 mounted on the attachment device 10 at its installation position in a lighting apparatus 1 of a motor vehicles and particularly a passenger car. The fan 20 is mounted on and can be removed from the attachment device 10 by three bolts 21. At the installation position, the bolts 21 tilt towards the opening 2 in the lighting apparatus 1 such that said bolts 21 cannot be moved by a tool. In this design variant of the lighting apparatus 1, the fan 20 has thus been mounted on the attachment device 10 prior to installation in the lighting apparatus 1. The attachment device 10 is mounted on the inside of the lighting apparatus 1 by means of the bolts 13 which are held in a captive manner by the guiding elements 14 of the mounting devices 11. The opening 2 in the lighting apparatus 1 provides easy access to the bolts 13 such that they can be easily turned by means of a tool, particularly a screwdriver. In case a defective fan needs to be replaced, it can be easily removed from the lighting apparatus 1, particularly the headlamp of a vehicle, by removing the bolts 13 from the attachment device 10. The opening 2 is big enough to remove and install both the attachment device 10 and the fan 20 through it.

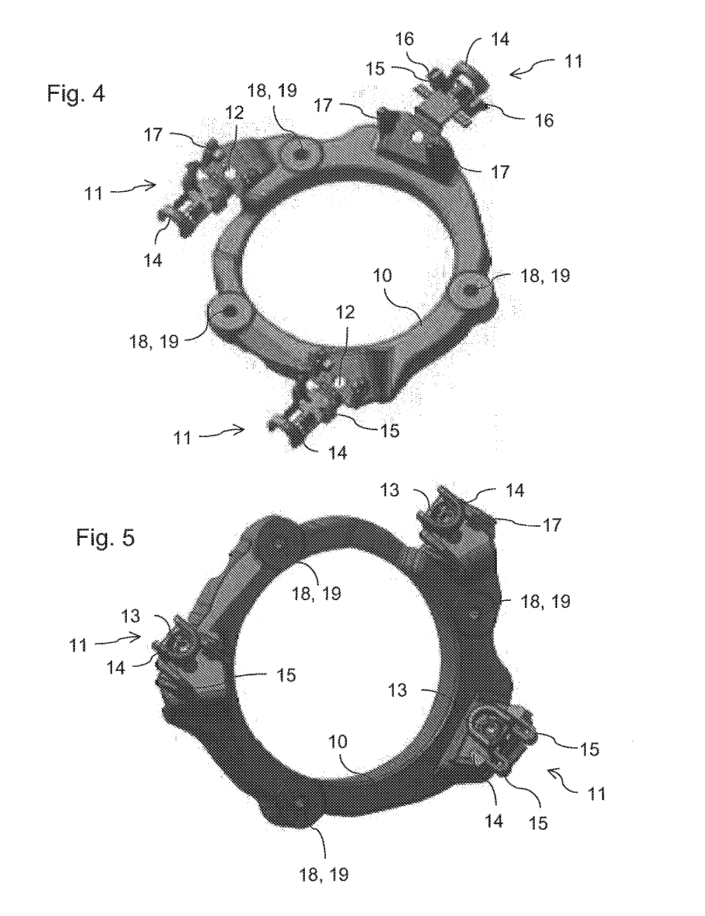

FIG. 4 and FIG. 5 each show an attachment device 10. Integral hinges swivel-mount the guiding elements 14 to the attachment device 10. The guiding elements 14 are designed as captive holder of one bolt 13 each as illustrated in FIG. 5. The guiding elements 14 provide access to the bolts 13 such that they can be loosened; once loosened, the bolts 13 are held by the guiding elements 14. When the guiding elements 14 are closed, i.e. if they at their mounting position as shown in FIG. 5, the bolts 13 are located in front of and aligned with the through-holes 12 in the mounting devices 11. This allows said bolts 13 to be easily screwed into or removed from the through-holes 12 while being held in a captive manner. The guiding elements 14 of the mounting devices 11 comprise locating elements 15. That is to say, resilient lugs 16 are provided on the guiding elements 14 such that said lugs 16 slot into fixed snap-in slots 17 protruding from the attachment device 10 to fasten the guiding elements at their installation position on the attachment device 10. The bolts 13 moving along the long axis in the guiding elements 14 help to mount the attachment device 10 on the lighting apparatus and particularly on the inner wall of the housing of the lighting apparatus or on a frame located inside the lighting apparatus and also to remove the attachment device 10 from these components. At their mounting position shown in FIG. 5, the bolts 13 in the guiding elements 14 are screwed into the matching through-holes 12 in the mounting devices 11 of the attachment device 10. FIG. 4 and FIG. 5 each show three mounting elements 19 used to attach a fan. The mounting elements 19 comprise through-holes or pocket holes 18 that bolts can be screwed into in order to attach and hold the fan.

Attachment devices of the aforementioned type support the quick and easy replacement of a defective fan 20 residing in a lighting apparatus 1, particularly a headlamp of a vehicle. A defective fan does not demand the entire lighting apparatus 1 to be replaced.

The fan 20 preferably comprises at least one rotating blade. The fan 20 or the lighting apparatus 1 further and preferably comprises a driving unit for operating the fan 20 and/or the rotating blade of the fan 20.

The replaceable fan bracket 10 is preferably a low-noise mount, wherein the fan position is independent of the opening 2 in the headlamp housing. The bolts 13 or the screwing direction of the bolts 13 can be easily accessed through the opening 2 in the lighting apparatus such that replacing the fan is supported. The attachment device 10 not only supports the easy replacement of the fan 20 but preferably also the noise-reducing seating of the fan 20. Due to the fact that the fan 20 can be previously mounted on the fan bracket 10, the arrangement or position of the fan 20 is fully configurable. Due to the mounting position of the fan 20 on the fan bracket being fully adjustable, the position can be optimized in relation to the elements in the headlamp to be cooled.

Due to the fact that the fan 20 can be previously mounted on the fan bracket 10, the attachment device 10 supports any geometric arrangement of the fan 10 inside the lighting apparatus 1.

In view of the foregoing, it will be seen that several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

### REFERENCE ITEMS

1 lighting apparatus
2 opening
10 attachment device/fan bracket
11 mounting device
12 through-hole
13 bolt
14 guiding element
15 locating element
16 lug
17 snap-in slot
18 through-hole
19 mounting element
20 fan
21 bolt

We claim:

1. A device for attaching a fan of a lighting apparatus, comprising at least one mounting element for mounting the fan and at least one mounting device for mounting the device inside the lighting apparatus.

2. The attachment device of claim 1, further comprising an unthreaded hole or a hole with an inside thread along at least some of its length through the at least one mounting device, said hole being configured to hold a bolt.

3. The attachment device of claim 1, further comprising at least one mounting device comprising a conduit for the captive ducting of a bolt.

4. The attachment device of claim 3, further comprising the conduit is friction-locked to the attachment device, but removable from it and/or that the conduit is mounted to the attachment device such that it is pivoting.

5. Attachment device of claim 3, further comprising the conduit forms an integral whole with the attachment device.

6. Attachment device of claim 1, further comprising the at least one mounting element has a plain hole with or without an inside thread or a pocket hole with or without an inside thread through it.

7. The attachment device of claim 6, further comprising the plain hole through the at least one mounting device tilts towards the plain hole or pocket hole through the at least one mounting element.

8. A lighting apparatus for a vehicle, comprising:
a light source;
a fan;
a housing;
the light source being mounted inside and/or to the housing;
the lighting apparatus comprising an attachment device for the fan comprising at least one mounting element for mounting the fan and at least one mounting device for mounting the device inside the lighting apparatus;
the housing of the lighting apparatus having an opening for inserting the attachment device and the fan, wherein the attachment device is mounted to but removable from the housing of the lighting apparatus such that the attachment device can be mounted in/to and dismounted from the housing of the lighting apparatus through an insertion opening.

9. The lighting apparatus of claim 8, further comprising the attachment device and/or the light source is mounted on and removable from a frame inside the housing of the lighting apparatus.

10. The lighting apparatus of claim 8, further comprising the light source comprising at least one light emitting diode.

11. The attachment device of claim 4 wherein the conduit is friction locked to the attachment device by a locking element.

12. The attachment device of claim 4 wherein the pivoting is on an integral hinge.
